(19) United States
(12) Patent Application Publication
(10) Pub. No.: US 2011/0076907 A1
(43) Pub. Date: Mar. 31, 2011

(54) Apparatus and method for melt spun production of non-woven fluoropolymers or perfluoropolymers

(76) Inventors: Charles A. Glew, Pawcatuck, CT (US); David Braun, North Attleboro, MA (US); Simon Philip Slack, Cleckheaton (GB)

(21) Appl. No.: 12/586,658

(22) Filed: Sep. 25, 2009

(51) Int. Cl. D04H 1/56; B29C 47/30; D02G 3/02

(52) U.S. Cl. 442/400; 425/72.2; 428/364

(57) ABSTRACT

Disclosed is an apparatus, process, and product allowing for the manufacture of non-woven fluoropolymers, perfluoropolymers, and high temperature engineering resin filaments obtained from low melt index polymers. The fibers have continuous structural integrity created by using a heated duct that provides for maintaining an elevated filament temperature during filament draw down. The apparatus allows for entanglement and melt bonding of the fluoropolymers perfluoropolymers, and high temperature engineering resin filaments.

### FIELD OF DISCLOSURE

This disclosure relates to an apparatus and process for producing fluoropolymer or perfluoropolymer non-woven and spun-bonded fiber products. More particularly, it relates to an apparatus used in conjunction with a fiber draw for producing fluoropolymer or perfluoropolymer filaments or both fluoropolymer and perfluorpolymer for non-wovens.

### BACKGROUND OF DISCLOSURE

Devices for producing non-woven thermoplastic fabric webs from extruded polymers through a spinneret that form a vertically oriented curtain with downward advancing filaments and air quenching the filaments, in conjunction with a suction-type drawing or attenuating air slot, are well known in the art.

The conventional manner of making such non-wovens with thermoplastic polymers such as polypropylene, polyethylene, polyester, nylon, and blends thereof is known. In the first step, the polymer is melted and extruded through a spinneret to form the vertically oriented curtain of downwardly advancing filaments. The filaments are then passed through the quench chamber where they are cooled down by chilled air, reaching a temperature at which the crystallization of the filament starts, resulting in the solidification of the filaments. A drawing unit located in a fixed position below the quench chamber provides suction with an air slot where compressed air is introduced into the slot, thus drawing air into the upper open end of the slot which forms a rapidly moving downstream of air into the slot. This air stream creates a drawing force on the filaments causing them to be attenuated or stretched and exits the bottom of the slot where they are deposited on a moving conveyor belt to form a continuous web of the filaments. The filaments of the web are then joined to each other through additional conventional techniques.

Non-woven materials are presently mainly produced from man-made fibers. Two synthetic polymers dominate the market: polypropylene (PP) and polyesters (mainly polyethylene terephthalate or PET). Nonwovens are often application-designated as either durable or disposable. For example, nonwovens used as housewraps to prevent water infiltration are durable nonwovens. Nonwovens used as facings on baby diapers are disposable or single-use nonwovens.

Spunlaid or spunbonded nonwovens are made in one continuous process. Fibers are spun and then directly dispersed into a web by deflectors or can be directed with air streams. This technique leads to faster belt speeds, and cheaper costs. Polypropylene spunbonds run faster and at lower temperatures than PET spunbonds, mostly due to the difference in melting points. Spunbond products have been combined with meltblown nonwovens, conforming them into a layered product called SMS (spun-melt-spun). Meltblown nonwovens have extremely fine fiber diameters and short fiber lengths and therefore do not typically produce strong fabrics. SMS fabrics made completely from polypropylene are water-repellent and fine enough to serve as disposable fabrics. Meltblown products are often used as filtration media, due to the ability to capture very fine particles as the meltblown “fabric” or web is completed. Spunlaid products can be bonded by either thermal or resin adhesion means.

Fluoropolymers or perfluoropolymers and other high temperature engineering resins, such as polyetheretherketone (PEEK), polyphenylene sulfide (PPS), polyetherimide (PEI), polyethersulfone (PES), polysulfone (PSU), polyphenylsulfone (PPSU) or polyetherketoneketone (PEKK) have not generally been considered for fiber spinning, spunbonded or meltblown non-woven applications due to the high temperatures required to extrude the high temperature resin or fluoropolymer materials and the rapid solidification of the extrudate to below the glass transition temperature as it exits the spinneret. As the high temperature extrudate exits the spinneret, melt fracture rapidly occurs and the result is an incomplete fiber spinning and unsatisfactory non-woven of low structural strength.

### RELEVANT ART

U.S. Pat. No. 6,013,223 to Schwarz, Eckhard C A, and assigned to Biax-Fiberfilm Corp, which describes an improved apparatus for producing fibers of a high degree of molecular orientation of the type wherein a fiberforming thermoplastic polymer is formed into a fiber stream and wherein the fibers are collected on a receiver surface in the path of the fiber stream to form a non-woven mat. A polymer feed chamber for receiving the molten polymer, nozzle mounts having a plurality of nozzle means mounted in a spinneret plate arranged in multiple rows for receiving the molten polymer from the polymer feed chamber forms a fine fiber and has a multiplicity of nozzles arranged in at least two rows, a gas cavity having a height of at least two times the outside diameter of the nozzles, a gas plate to receive the nozzles with the gas plate having a hole pattern identical to the nozzle mounts and having holes which are larger than the outside diameter of the nozzles to pass gas from the gas cavity around the nozzles at high velocity to flow and expand parallel to the nozzles having ends protruding through the gas plate and the flow of the fibers exiting the nozzle ends. There is also a jet drawing means placed at a distance from the nozzles in the path of the fiber stream, receiving the fiber stream, and having air slots directing a flow of high velocity cold air away from the nozzles with the high velocity cold air accelerating the fiber stream away from the nozzles at a high velocity.

U.S. Pat. No. 5,476,616 to Schwarz, Eckhard C A, and assigned to Biax-Fiberfilm Corp, which describes an improved apparatus for producing melt blown fibers of the type wherein a fiberforming thermoplatsic polymer is formed into a fiber stream and wherein the fibers are collected on a receiver surface in the path of the fiber stream to form a non-woven mat. A polymer feed chamber for receiving the molten polymer; a plurality of nozzles means nozzles mounted in a spinneret plate arranged in multiple rows for receiving the molten polymer from the polymer feed chamber and for forming fine melt blown fibers and has a multiplicity of nozzles arranged in at least four rows, a nozzle spacing at least 1.3 times the outside nozzle diameter, a first gas cavity having a height of at least six times the outside diameter, a first gas plate to receive the nozzle. The gas plate has the same hole pattern as the nozzle mounts and has gas holes intermittently spaced between the nozzle holes through which the gas passes into a second gas cavity formed by a spacer plate and a second gas plate. The second gas cavity has a height of at least one half of the nozzle diameter, a second gas plate has a hole pattern identical to the nozzle mounts and has holes which are larger than the outside nozzle diameter of the nozzles to pass gas from the second gas cavity around the nozzles at high velocity to form the fibers.

U.S. Pat. No. 4,380,570 to Schwarz, Eckhard, C A, and assigned to Biax-Fiberfilm Corp, which describes a process for producing melt blown fibers from a molten fiber forming thermoplastic polymer and wherein the molten fiber forming thermoplastic polymer is further heated and extruded through orifices of heated nozzles into a stream of hot gas to attenuate the molten polymer into fibers forming a fiber stream. The fiber stream is collected on a receiver surface in the path of the fiber stream to form a non-woven mat passing the molten polymer through an elongated channel and thence through a plurality of sub-channels to a molten polymer feed chamber where the molten polymer has a resident time through the channels of less than 30 seconds. Heating the molten polymer during the previous step to a temperature where a thermal diffusivity of the molten polymer, (1) is the length of each polymer channel and (Q) is the polymer flow rate in each polymer channel. The heated molten polymer is passed from the feed chamber through a plurality of heated nozzles to form the melt blown fibers. The molten polymer has a residence time in the heated nozzles of less than 2 seconds and further heating the heated molten polymer during the previous step to a temperature where there is a thermal diffusivity of the molten polymer and the second molten polymer forms the melt blown fibers exhibiting an apparent melt viscosity of less than 45 poise. The second molten polymer introduced into the elongated chamber is at a temperature of at least 40 degrees F. lower than the temperature of the melt blown fibers.

U.S. Pat. No. 5,645,790 to Schwarz, Eckhard, C A, and assigned to Biax-Fiberfilm Corp, which describes an improved apparatus for producing fibers of a high degree of molecular orientation of the type where a fiber forming thermoplastic polymer is formed into a fiber stream and where the fibers are collected on a receiver surface in the path of the fiber stream to form a non-woven mat, the improvement of which has: a polymer feed chamber for receiving said molten polymer, nozzle mounts having a plurality of nozzle means mounted in a spinneret plate arranged in multiple rows for receiving molten polymer from the polymer feed chamber for forming fine fiber, and having:
a) a multiplicity of nozzles arranged in at least two rows;
b) a gas cavity having a height of at least two times the outside diameter of the nozzles;
c) a gas plate to receive the nozzles with a hole pattern identical to the nozzle mounts and having holes which are larger than the outside diameter of the nozzles to pass gas from the gas cavity around the nozzles at high velocity to flow and expand parallel to the nozzles having ends protruding through the gas plate and the flow of the fibers exiting the nozzle ends,
d) a jet thawing means, placed at a distance from the nozzles in the path of the fiber stream, receiving the fiber stream and having air slots directing a flow of high velocity cold air away from the nozzles. The high velocity cold air accelerates the fiber stream away from the nozzles at a high velocity.

U.S. Pat. No. 6,174,601 to Stanitis, et. al., and assigned to Ausimont USA, Inc., which describes a sheath-core bicomponent fiber having a core component of a first spinnable polymer material selected from the group consisting of nylon, nylon and polyester copolymer, nylon and polyolefin copolymer and a sheath component of a second polymer material selected from the group consisting of a co-polymer of at least ethylene and chlorotrifluoroethylene where the co-polymer of ethylene and has a non 1:1 molar ratio of ethylene to chlorotrifluoroethylene and a volume crystallinity between about 1% and 49%.

U.S. Pat. No. 6,316,103 to Stanitis, et. al., and assigned to Ausimont USA, Inc, which describes a sheath-core bicomponent fiber having a core component of a first spinnable polymer material selected from the group consisting of polyethylene, polyester, polypropylene, polyolefin, copolymers thereof and a sheath component of a second polymer material selected from the group consisting of a co-polymer of at least ethylene and chlorotrifluoroethylene where the co-polymer of ethylene and chlorotrifluoroethylene has a non 1:1 molar ratio of ethylene to chlorotrifluoroethylene and a volume crystallinity between about 1% and 49%.

U.S. Pat. No. 5,688,468 to Lu, Fumin, and assigned to Ason Engineering, Inc., which describes a process for forming a spunbond, non-woven, polymeric fabric from a plurality of polymeric extruded filaments having the steps of; extruding a plurality of vertically oriented filaments by melt-spinning through a spinneret from a thermoplastic polymer; threading the filaments through the slot with drawing means positioned at least 100 cm from the spinneret, using reduced throughput and nominal air pressure of 10 to 20 psig; increasing the air pressure and the throughput coordinately, while simultaneously reducing the distance between the spinneret and the drawing means until the distance between the spinneret and the drawing means is between 5 to 150 cm whereby the size of the filaments can be controlled by the distance between the drawing means and the spinneret; forming a web of a spunbound, non-woven polymeric fabric on a web-forming means positioned optimally below the drawing means where the size of the filaments can be controlled by the distance between the drawing means and the spinneret to form a uniform web with desired properties.

U.S. Pat. No. 4,847,035 to Mente, et. al., and assigned to J. H. Benecke, A G., which describes a process for the production of non-woven materials from endless filaments and a substrate having the steps of: supplying to an input side of a filament draw-off nozzle a first gaseous propellant having a first predetermined input pressure and input volume to establish a filament draw-off force which draws endless filaments in the form of a warp from spinnerets into one end of a filament guide tube and moves said warp downwardly through the filament guide tube. The filament is directed in a substantially downward direction into the downwardly moving warp with a second gaseous propellant having a second predetermined input pressure and input volume that is lower than the first predetermined input pressure and input volume through at least one downwardly directed propelling nozzle. The warp is spread at another end of the filament guide tube with a spreading extruder that is attached to the filament guide tube so that the individual filaments form in a substantially uniform manner on a substrate located below the spreading extruder to obtain a non-woven material.

U.S. Pat. No. 4,818,466 to Mente, et. al., and assigned to J. H. Benecke, A G., which describes a process for the production of a non-woven material from endless filaments and a substrate having the steps of supplying to an input side of a filament draw-off nozzle a first gaseous propellant having a first predetermined input pressure and input volume to establish a filament draw-off force which draws endless filaments from spinnerets in the form of a warp into one end of a filament guide tube and moves the warp downwardly through the filament guide tube spreading the warp at the other end of the filament guide tube with a spreading extruder having Coanda shells that is attached to the filament guide tube so that the individual filaments are distributed in a substantially uniform manner on a substrate located below the Coanda shells. The filament is directed in a substantially downward direction at a location immediately above the Coanda shells by a second gaseous propellant having a second predetermined input pressure and input volume that is lower than the first predetermined input pressure and input volume with at least one slot nozzle having a narrowing cross-section with its narrowest cross-section at an output opening to obtain further uniformity of the individual filaments distributed on the substrate to obtain a non-woven material.

U.S. Pat. No. 4,818,463 to Buehning; Peter G., and unassigned, which describes a process for producing a non-woven web of thermoplastic polymer fibers by extruding thermoplastic polymer through a row of die openings in a triangular cross-sectional die head of a die body and discharging a gas along the entire length of the die onto each side of the molten resin as it is extruded to attenuate the molten resin as fibers in a plane away from the die openings. The gas has a substantially uniform velocity along the length of the die wherein the gas for each side is passed sequentially through a pipe discharging the gas through a slit or plurality of holes into an air chamber designed to provide uniform velocity gas along the length of the air chamber. The gas from the air chamber is discharged through a plurality of flow distribution holes in the die body and the gas discharging from the flow distribution holes flows into a longitudinal groove in the die body as a plurality of streams. The groove has a gas deflector assembly to intermix the streams of gas discharging from the flow distribution holes and form the gas of substantially uniform velocity along the length of the die. The attenuated thermoplastic polymer fibers are collected on a receiver in the path of the plain to form a nonwoven web.

U.S. Pat. No. 6,551,545 to Hutter, et. al., and assigned to Barmag A G, which describes a process for melt spinning a multifilament yarn having the steps of extruding a heated polymeric melt through a spinneret to form a plurality of downwardly advancing filaments which are initially in liquid form, precooling the filaments by contact with a coolant which is introduced into a cooling zone which is located downstream of the spinneret in such a manner that the filaments do not solidify within the cooling zone. The filaments are further cooled in a tension zone located downstream of the cooling zone by contact with a coolant stream in such a manner that the filaments solidify within the tension zone, adjustably controlling the cooling of the filaments within the cooling zone in such a manner that the location of the solidification of the filaments within the tension zone is maintained within a predetermined desired range and gathering the advancing filaments downstream of the tension zone to form an advancing multifilament yam and winding the advancing yarn into a package.

U.S. Pat. No. 6,607,624 to Berrigan, et. al., and assigned to 3M Innovative Properties Inc., which describes a method for making fibers by extruding filaments of fiber-forming material and directing the filaments through a processing chamber defined by two parallel walls where at least one of the walls is instantaneously movable toward and away from the other wall and is subject to movement for providing instantaneous movement during passage of the filaments and processing the filaments through the processing chamber continuing essentially uninterrupted during the instantaneous movement of the wall(s) such that a substantially uniform web can be collected during the movement where the processed filaments are collected.

U.S. Pat. No. 6,824,372 to Berrigan, et. al., and assigned to 3M Innovative Properties Inc., which describes an apparatus for forming fibers having an extrusion head for extruding filaments of fiber-forming material through orifices in a die. There is a processing chamber aligned to receive the extruded filaments for passage through the chamber with the chamber being defined by two parallel walls where at least one of the walls is instantaneously movable to allow an instantaneous separation and reclosing of the walls during which processing of filaments continues essentially uninterrupted and a movement means for providing instantaneous movement of at least one wall.

U.S. Pat. No. 6,969,441 to Welch, et. al., and assigned to Kimberly-Clark Worldwide, Inc., which describes a method for producing a composite nonwoven fabric in a vertical plane, by providing an extruder having a plurality of die heads; a vertically-arranged series of first and second chilled rollers, and a set of nip rollers. The extruder is located above the vertically-arranged series of first and second chilled rollers with the first chilled roller being positioned vertically below the extruder so that extruded filaments from the extruder flow directly to the first chilled roller. The second chilled roller is positioned vertically below the first chilled roller and located before the set of nip rollers so that the extruded continuous filaments flow directly from the first chilled roller to the second chilled roller and then directly to a nip formed by the set of nip rollers. The extruding heated continuous filaments from the die heads of the extruder move directly to the first chilled roller where the extruder is further configured to provide the continuous filaments to the first chilled roller in a canted direction that is tangent to the surface of the first chilled roller thereby conveying the continuous filaments directly from the first chilled roller to the second chilled roller. The continuous filaments are then quenched and stretched simultaneously to form stretched continuous filaments conveying the stretched continuous filaments directly from the second chilled roller to the nip providing at least one nonwoven web. An adhesive is applied on the surface of the one nonwoven web and then providing the one nonwoven web to the nip and laminating the stretched continuous filaments with the nonwoven web in the nip to form a composite nonwoven fabric.

U.S. Pat. No. 7,018,188 to James, et. al., and assigned to The Procter & Gamble Company, which describes an apparatus for forming fibers having a die assembly including a fiber material supply cavity for receiving material to be formed into fibers and an attenuation medium inlet; a spinneret assembly including a plurality of nozzles, one or more attenuation medium passages and a discharge opening where the nozzles are disposed in the spinneret assembly such that at least some of the nozzles are in fluid communication with the fiber material supply cavity. The attenuation medium passage has a minimum cross-sectional area and a cover plate disposed adjacent to at least a portion of the spinneret assembly with the cover plate having a cover plate opening into which one or more of the nozzles may extend. The cover plate opening has a limiting cross-sectional area wherein the minimum cross-sectional area of the one or more attenuation medium passages is greater than the limiting cross-sectional area of the cover plate opening.

U.S. Pat. No. 5,401,458 to Wadsworth, et. al., and assigned to Exxon Chemical Patents Inc., which describes a melt blowing process where thermoplastic polymer is extruded from a plurality of orifices, attenuating and stretching filaments formed by the thermoplastic polymer by converging air streams and collecting the filaments. The improvement are where the thermoplastic polymer is an ethylene-fluorocarbon copolymer having a melt index of at least of 100 and melting point of at least 200.degree C. and where each orifice has a flow area greater than 0.31 mm².

Melt blowing equipment for carrying out the process generally comprises an extruder, a melt blowing die, a hot air system, and a collector. The present invention utilizes special heating techniques as follows; a polymer melt received by the die from the extruder is further heated and extruded from a row of orifices as fine filaments while converging sheets of hot air (primary air) discharging from the die contact the filaments and by drag forces stretch the hot filaments to microsize. The filaments are collected in a random entangled pattern on a moving collector screen such as a rotating drum or conveyor forming a nonwoven web of entangled microsized fibers. (The terms “filaments” and “fibers” are used interchangeably herein). The filaments freeze or solidify a short distance from the orifice aided by ambient air (secondary air). Note, however, that the filament stretching by the primary air drag forces continues with the filaments in the hot solidified or semi-solidified state.

### OBJECT OF THE INVENTION

It has been found that conventional methods to produce non-woven fluoropolymers or perfluoropolymers or special high temperature engineering resins including, but not limited to; polyetheretherketone (PEEK), polyphenylene sulfide (PPS), polyetherimide (PEI), polyethersulfone (PES), polysulfone (PSU), polyphenylsulfone (PPSU) or polyetherketoneketone (PEKK) by extruding have been unsuccessful due to fracturing of the individual fluoropolymer or perfluoropolymer filament. The high temperature melting polymers include those exhibiting a melt flow index less than or equal to 100 MI such as HALAR 500 LC (MI=15-20) and HALAR 1450 LC (MI=50), which is ECTFE as well as FEP, PFA, MFA, PVDF, ETFE, and TFE.

Disclosed is an apparatus and method for producing non-woven fluoropolymers or perfluoropolymers filaments with continuous structural integrity by including an additional heated duct that provides added insulation and additional heat to a multiple orifice spinneret in order to maintain an elevated filament temperature.

Disclosed is an apparatus and method for spun melt fluoropolymers or perfluoropolymers of low melt flow index where, in combination, a fluoropolymer or perfluoropolymer is vertically or horizontally extruded through a heated multiple orifice spinneret with hot fluid circulated around and through the spinneret such that the extruded fluoropolymer or perfluoropolymer fiber exits the spinneret into a heated chamber located between the spinneret and a die cover plate having orifices located centrally and axially surrounding the extruded fluoropolymer or perfluoropolymer orienting the fiber such that hot air or fluid jets provide a hot air or fluid flow parallel to the fluoropolymer or perfluoropolymer fiber drawing the fluoropolymer or perfluoropolymer fiber within a heated chamber shroud located directly between the die cover plate and spinning nozzle exit and the receiving medium such that the heated chamber duct temperature is maintained above the melt temperature of the fluoropolymer or perfluoropolymer at the hot air orifices to prevent fracturing.

In one embodiment the fluoropolymer or perfluoropolymer fibers will remain continuous due to the maintenance of the temperature within the heated chamber shroud and with the presence of a pressure drop as the fluoropolymer or perfluoropolymer fibers exit the orifice which enables the melt bonding of the fluoropolymer or perfluoropolymer fibers into non-woven filaments.

In a particular embodiment the inside cavities within the spinneret nozzles narrow these spinneret nozzles which narrows the flow of the filament within the spinneret nozzles and providing variable diameters within an initially constant diameter orifice which is the spinneret nozzles.

In a particular embodiment the hot air exits the hot fluid orifice in a relatively parallel alignment between the hot fluid orifice, inside cavity, and spinneret nozzles and aid in imperfect alignment and imperfect entanglement of the filaments prior to or on the receiving medium.

In an embodiment of the disclosure, the air temperature of the fluid chamber prior to accessing the die cover plate hot air orifices section, is maintained at 90-150 degrees centigrade above the melt temperature of the fluoropolymer or perfluoropolymer. This air temperature is achieved by preheating compressed air or by use of a heater rod (electrical resistance) heating of the spinneret.

In another embodiment the heated chamber apparatus is a passively heated duct between the die cover plate and receiving medium with the relatively axially located air orifices or holes encircling each spinneret orifice directing the heated air axially along and around each fiber.

In another embodiment the spinneret may be rectangular or curved with spinneret orifices projecting perpendicular to the spinneret exterior surface. For example the spinneret can be rectangular in shape and 10 inches wide with 850 nozzles, 2 air curtain rows and 7 active rows (where polymer flows and exits in the middle region of the spinneret).

In another embodiment the heated chamber apparatus may utilize the air temperature of the spinneret for cooling.

In another embodiment the heated chamber apparatus may be insulated to maintain the desired air temperature and gradient air temperature drop.

In another embodiment the vertical extrusion reduces the volume of heated air required as opposed to horizontal extruding.

In another embodiment the size of the spinneret orifice and air orifice influences the air pressure drop and adiabatic cooling.

In another embodiment, the specific gravity of the high viscosity low melt index fluoropolymer, perfluoropolymer or high temperature engineering resin filaments is sufficient to overcome air resistance when the heated fluid (air) is directed and blown in the same direction as the polymeric filaments.

The apparatus is designed for producing fibers larger than 30 microns in diameter—that are lightweight and provide lofty (high air entrapment levels) non-woven polymer wraps that could be used in lieu of a glass tape. This non-woven product developed using this equipment provides for a lighter and more flammability resistant and low or no smoke product which are not properties of the conventional non-wovens. This non-woven also will exhibit strength (axial and biaxial) exceeding that of glass or polyester tapes with or without aluminum backing.

In another embodiment the heated chamber apparatus maintains the fluoropolymer or perfluoropolymer filament temperature above the fluoropolymer or perfluoropolymer resin melt temperature to allow for filament bonding.

In another embodiment the vertical heated chamber apparatus allows for prevention of premature filament fracturing.

In another embodiment the filaments may be obtained via equipment that is positioned in the vertical, horizontal or any other angle.

In another embodiment the spinneret orifices provide filaments with a melt flow index of no greater than 100 including the use of Halm 500 LC with a melt flow index of 15-20.

In another embodiment the receiving medium receives the filaments perpendicular to the receiving medium surface.

In another embodiment a vacuum is applied to the receiving medium surface for aiding the filament bonding.

In another embodiment melt bonding is calendered, needled, spun bonded, chemically bonded or by other bonding.

In another embodiment the filaments are calendered to ensure the melt bonded mat is within specific tolerances.

In another embodiment the melt bonded mat may be post drawn in machine direction or cross direction for additional strength and/or sizing.

In another embodiment the fluid cavity air temperature would be in the range of 550 Deg. F.-800 Deg. F.

In another embodiment the fluid cavity air would be isolated/insulated from the spinneret.

In another embodiment the nozzles are made of Inconel®.

In another embodiment, the inside diameter of the nozzles are in the range of 0.023-0.028 inches and up to 0.05 inches (50 mils or 1.27 millimeters) resulting in a final filament diameter of 10 to 200 microns. Fiber diameter size is determined by orifice size and polymer flow rate and fiber orientation rate. The resulting filaments are continuous filaments in that there is no discontinuity of the filaments during spinning.

In another embodiment a through-air bonder attachment may be used to aid in bonding the filaments during processing. The term “through air bonder” is intended to mean any bonder that directs energy towards the filaments causing at least a portion of some of the filaments to sufficiently tackify as to form a physical bond; draw air through the layers while at least a portion of some of the filaments are tacky creating pressure on the filaments and controlling the loft or z-direction length of the layers; and prevents the liquid impervious depressions caused by calendaring.

In another embodiment the non-woven mat is a hybrid such that the filaments are produced like melt blown filaments with strength of spun bonded filaments.

In another embodiment, the nozzle openings are normally greater than 0.89 mm, but may exist within a range of 0.55 mm to 1.25 mm with the proper melt index for forming continuous filaments.

In another embodiment, when utilized in the vertical direction the spinneret assembly may also be heated using heating rods (137) to elevate and maintain the desired temperature as shown on FIG. 1.

In one particular embodiment the heated and/or insulated chamber shroud which is located on the filament side of the spinneret is brought to a sufficiently high temperature prior to the filament entering the shroud so that filament spinning of the high temperature polymers can be controlled to achieve the desired articles of manufacture. The shroud [165] is located on the fiber side of the spinneret- and the shroud is normally about 6″ to 3′ away from the spinneret surface.

In another embodiment, the nozzle/die temperatures must be within a range of 550 to 750 degrees Fahrenheit in the die body, just before coming out of the spinneret and the temperature just below the nozzle/die drops precipitously (about 90 Degrees F.) due to adiabatic cooling almost immediately upon exiting the die.

### BRIEF DESCRIPTION OF THE DRAWINGS

FIG. 1 is a section view of the fluoropolymer or perfluoropolymer process with the heated air duct in the vertical position.

### DETAILED DESCRIPTION OF THE DRAWINGS

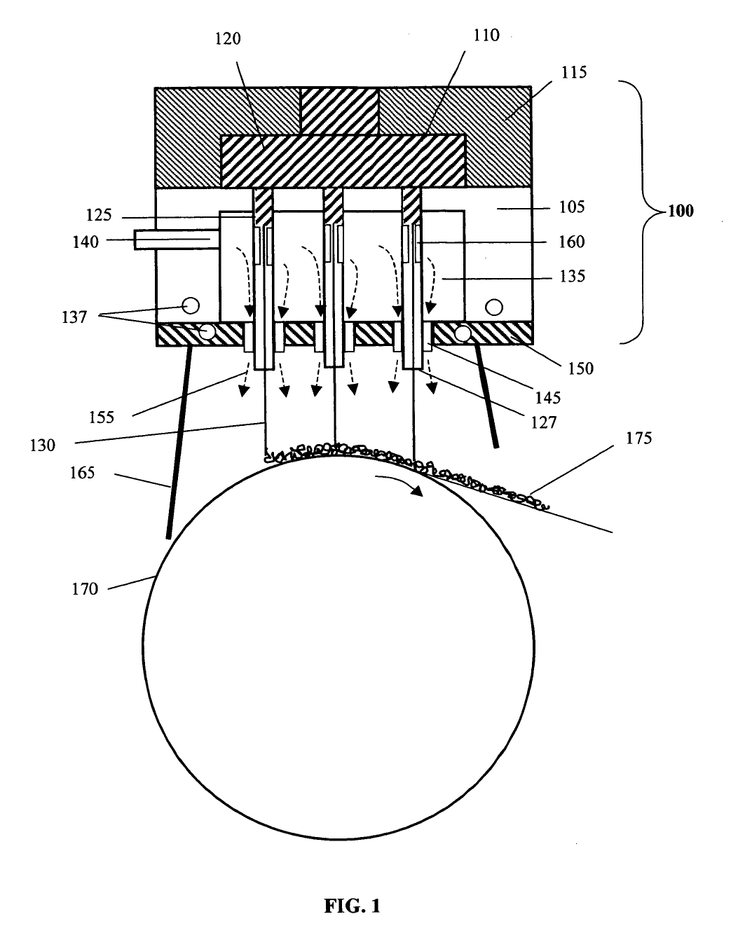

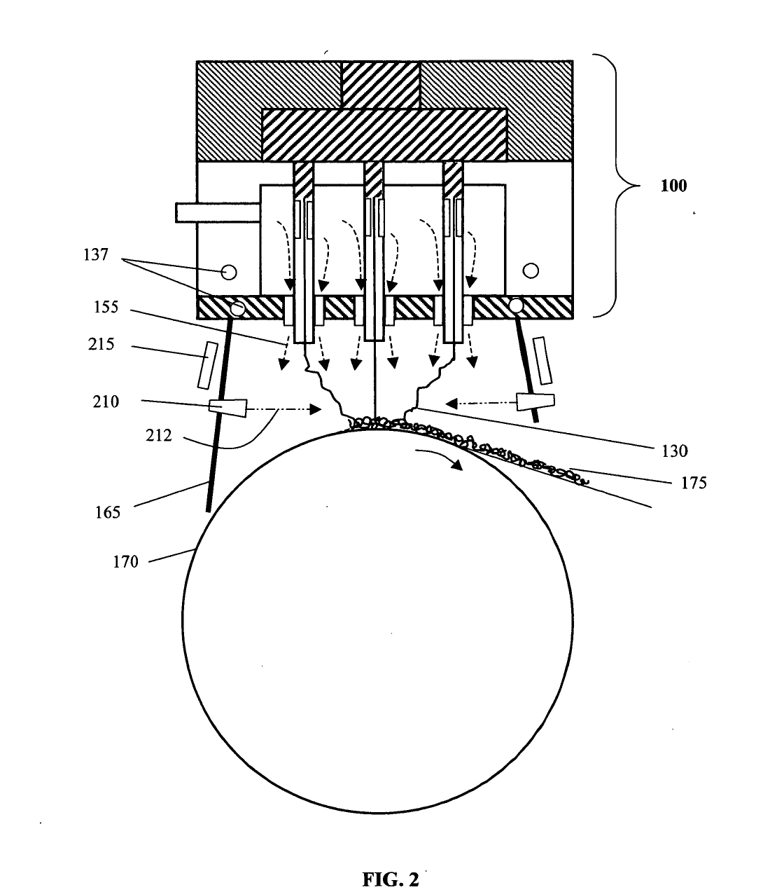

Referring now to FIG. 1, the spinnerette assembly [100] is mounted on die body [115] which supplies fluoropolymer or perfluoropolymer resin [110] melt to a supply cavity [120] feeding the spinneret nozzles [125] which are mounted in the spinnerette body [105] wherein nozzles [125] are spaced a desired distance from each other. Molten fluoropolymer or perfluoropolymer resin [110] is pumped through the inside cavity [160] of nozzle [125] to form a fiber after exiting at the end of the spinneret orifice [127]. The nozzles [125] lead through the fluid cavity [135] which is fed with air, gas or other suitable fluids from the gas inlet [140] that maintains a temperature in the range of 90-150 degrees C. above the melt temperature of the filaments [130] exiting the nozzle [125]. The spinneret assembly [100] may also be heated using heating rods [137] to maintain the desired temperature. The nozzles [125] protrude through the center of hot fluid orifices [145] in the cover plate [150]. The hot pressurized air from the fluid cavity [135] is exiting around each nozzle [125] through hot fluid orifice [145] and expanding at a high velocity parallel to the nozzles [125] and filaments [130]. The expanding gas [155] is exerting an accelerating force on the fibers [130] causing the filament to decrease in diameter and aligning the molecular structure. The hot air exits the hot fluid orifice [145] in a relatively parallel alignment between the hot fluid orifice [145] and spinneret nozzles [125] and aid in imperfect alignment of the filament [130] and imperfect entanglement prior to or on the receiving medium [170].

FIG. 2 illustrates an optional design with air jets [210] that allow for blowing the filaments [130] together prior to contact with the receiving medium [170]. The air [212] from the air jets [210] exerts a strong accelerating force on the filaments [130] providing a higher velocity and causing the filaments to be drawn [130] to a smaller diameter. The present invention allows for gravity and distance from the spinneret orifice to enhance the process. Specifically, as the spacing in the draw zone increases, the longer draw (due to gravity) creates smaller diameter fibers. In addition, the use of a greater volume and velocity of any fluid (normally air or other gases) provides more effective control of the fiber diameter if the fluid is a short distance from the spinneret orifice.

The fluoropolymer or perfluoropolymer filaments [130] enter a heated or insulated chamber shroud [165]. The heated chamber shroud [165] is passively heated from the air exiting from the hot fluid orifice [145] and may be heated via resistive heating (IR) [215]—through a shroud [165] of clear glass or via supplemental heated air introduced through and into the shroud [165] similar to the air jets [210] shown in FIG. 2. The shroud [165] is located on the fiber side of the spinneret—and the shroud is normally about 6″ to 3′ away from the spinneret surface.

The heated chamber shroud [165] may be solid or perforated and may be insulated. The heated chamber shroud [165] allows for slower cooling of the filaments [130] and prevents melt fracture of the filaments [130]. The filaments [130] maintain their structural integrity and as they contact adjacent filaments [130] begin to bond together into a high strength melt spun non-woven mat [175]. The high strength melt spun non-woven mat [175] contacts the receiving medium [170] which provides additional entanglement forming a bond that result in a high strength melt spun non-woven mat [175]. Additional processing such as calendering, needling, spin bonding, chemical bonding or melt bonded may occur subsequent to the receiving medium [170].

What is claimed is:

1. An apparatus using low melt flow index fluoropolymers or perfluoropolymers comprising; a heated multiple orifice spinneret allowing for hot fluid to circulate around and through spinneret nozzles of said spinneret such that extrusion flow of a fluoropolymer or perfluoropolymer reaches and passes through said spinneret nozzles into a fluid cavity located between said spinneret and a die cover plate having hot fluid orifices located centrally and axially within said spinneret surrounding said fluoropolymer or perfluoropolymer resulting in one or more oriented filaments in a manner such that fluid jets with hot fluid orifices provide a hot fluid flow mostly parallel to said fluoropolymer or perfluoropolymer filaments, and wherein drawing said fluoropolymer or perfluoropolymer filaments is accomplished within a heated chamber shroud that is a continuation of said fluid jets and located directly between said die cover plate with spinneret orifices and a receiving medium, where said heated chamber shroud maintains a temperature above the melt temperature of said fluoropolymer or perfluoropolymer filaments, thus preventing said fluoropolymer or perfluoropolymer filaments from fracturing.

2. The filaments of claim 1, wherein high temperature engineering resins other than fluoropolymers or perfluoropolymers are include but are not limited to; polyetheretherketone (PEEK), polyphenylene sulfide (PPS), polyetherimide (PEI), polyethersulfone (PES), polysulfone (PSU), polyphenylsulfone (PPSU) or polyetherketoneketone (PEKK).

3. The nozzles of claim 1, wherein inside cavities within said nozzles narrow within said spinneret nozzles, thereby narrowing said flow within said spinneret nozzles and providing variable diameters within an initially constant diameter orifice of said spinneret nozzles.

4. The apparatus of claim 1, wherein said hot fluid is air, said air exiting through said hot fluid orifices wherein a parallel alignment of said hot air orifices, said inner cavity and said spinneret orifice all provide aid in imperfect alignment and imperfect entanglement of said filaments on said receiving medium.

5. The apparatus of claim 1, wherein said heated chamber shroud prevents fracturing of said filaments and enables melt bonding of said filaments into a non-woven product.

6. The apparatus of claim 1, wherein said fluid cavity temperature is maintained at 90-150 degrees Centigrade above said melt temperature of said filaments.

7. The apparatus of claim 1, wherein said heated chamber shroud may be solid or perforated and is passively heated from said hot air exiting said hot fluid orifices.

8. The apparatus of claim 1, wherein said filaments are extruded via said spinneret, wherein said spinneret is positioned in a vertical or horizontal manner, or positioned at any angle between vertical and horizontal.

9. The apparatus of claim 1, wherein said spinneret is heated and comprises multiple orifices providing said filaments within a melt index range of no greater than 100.

10. The apparatus of claim 1, wherein said receiving medium receives said filaments generally perpendicular to the surface of said receiving medium.

11. The apparatus of claim 1, wherein said receiving medium provides a vacuum for said surface of said receiving medium further enabling said filaments to bond as said non-woven product.

12. The apparatus of claim 1, wherein said filaments are calendared, needled, spun bonded, chemically bonded or said melt bonded

13. One or more melt spun bonded fluoropolymer or perfluoropolymer filaments wherein said fluoropolymer or perfluoropolymer filaments are combined into a bonded non-woven product and wherein said filaments are produced in an apparatus using a heated multiple orifice spinneret allowing for hot fluid to circulate around and through spinneret nozzles such that extrusion flow of said filaments passes through said spinneret nozzles into a fluid chamber located between said spinneret and a die cover plate having orifices located centrally and axially within said spinneret surrounding said filaments in a manner such that fluid jets with hot fluid orifices provide a hot fluid flow mostly parallel to said fluoropolymer or perfluoropolymer filaments, and wherein drawing said fluoropolymer or perfluoropolymer filaments is accomplished within a heated chamber shroud that is a continuation of said fluid jets and located directly between said die cover plate with spinneret orifices and a receiving medium, where said heated chamber shroud maintains a temperature above the melt temperature of said fluoropolymer or perfluoropolymer filaments, thus preventing said fluoropolymer or perfluoropolymer filaments from fracturing.

14. The filaments of claim 13, wherein high temperature engineering resins other than fluoropolymers or perfluoropolymers are include but are not limited to; polyetheretherketone (PEEK), polyphenylene sulfide (PPS), polyetherimide (PEI), polyethersulfone (PES), polysulfone (PSU), polyphenylsulfone (PPSU) or polyetherketoneketone (PEKK).

15. The nozzles of claim 13, wherein inside cavities within said nozzles narrow within said spinneret nozzles, thereby narrowing said flow within said spinneret nozzles and providing variable diameters within an initially constant diameter orifice of said spinneret nozzles.

16. The melt spun bonded filaments of claim 13, wherein said hot fluid is air, said air exiting through said hot fluid orifices wherein a parallel alignment of said hot air orifices, said inside cavity and said spinneret orifice all provide aid in imperfect alignment and imperfect entanglement of said filaments on said receiving medium.

17. The melt spun bonded filaments of claim 13, wherein said heated chamber shroud prevents fracturing of said filaments and enables melt bonding of said filaments into a non-woven product.

18. The melt spun bonded filaments of claim 13, wherein said fluid cavity temperature is maintained at 90-150 degrees Centigrade above said melt temperature of said filaments.

19. The melt spun bonded filaments of claim 13, wherein said heated chamber shroud may be solid or perforated and is passively heated from said hot air from said hot fluid orifices.

20. The melt spun bonded filaments of claim 13, wherein said filaments are extruded via said spinneret, wherein said spinneret is positioned in a vertical or horizontal manner, or positioned at any angle between vertical and horizontal.

21. The melt spunbonded filaments of claim 13, wherein said spinneret is heated and comprises multiple orifices providing said filaments using fluoropolymers or perfluoropolymers or engineering resins exhibiting a melt index of no greater than 100.

22. The melt spunbonded filaments of claim 13, wherein said receiving medium receives said filaments generally perpendicular to the surface of said receiving medium.

23. The melt spun bonded filaments of claim 13, wherein said receiving medium provides a vacuum for said surface of said receiving medium further enabling said filaments to bond as said non-woven product.

24. The melt spun bonded filaments of claim 13, wherein said filaments are calendered, needled, spun bonded, chemically bonded or said melt bonded
